(19) United States
(12) Patent Application Publication
(10) Pub. No.: US 2025/0226683 A1
(43) Pub. Date: Jul. 10, 2025

(54) ELECTRONIC DEVICE AND POWER SUPPLY OPTIMIZATION METHOD THEREOF

(71) Applicant: ASUSTeK COMPUTER INC., Taipei City (TW)

(72) Inventors: Po-Chun Chen, Taipei City (TW); Chih-Hung Lee, Taipei City (TW); Chia-Yuan Chang, Taipei City (TW); Shih-Teng Chiu, Taipei City (TW)

(73) Assignee: ASUSTeK COMPUTER INC., Taipei City (TW)

(21) Appl. No.: 18/935,638

(22) Filed: Nov. 3, 2024

(30) Foreign Application Priority Data
Jan. 4, 2024 (TW) 113100486

(51) Int. Cl. H02J 7/00

(52) U.S. Cl. CPC H02J 7/00712; H02J 7/00032; H02J 7/0063; H02J 7/0068

(57) ABSTRACT

An electronic device and a power supply optimization method thereof are provided. The method includes: negotiating with a power adapter through a power control protocol in a power connection state to obtain a power profile; determining whether the power adapter supports a variable charging power adjustment function according to the power profile; when the power adapter supports the variable charging power adjustment function, determining whether a stored power of a battery module is less than a power threshold; when the stored power is less than the power threshold, executing one or more of a constant current test, a constant voltage test, and a power transmission test to select an algorithm for controlling a power supply behavior of the power adapter from multiple algorithms.

### CROSS-REFERENCE TO RELATED APPLICATION

This application claims the priority benefit of Taiwan application serial no. 113100486, filed on Jan. 4, 2024. The entirety of the above-mentioned patent application is hereby incorporated by reference herein and made a part of this specification.

### BACKGROUND

### Technical Field

The disclosure relates to an electronic device capable of controlling a power supply behavior of a power adapter and a power supply optimization method thereof.

### Description of Related Art

Considering environmental protection, handheld electronic products (for example, laptops, mobile phones, and tablets) by many manufacturers no longer come with power adapters when leaving the factory, and the power adapters need to be purchased separately. Consumers may use third-party power adapters, power adapters with poor adaptability, or power adapters that are not compliant, so the same high charging wattage capability as the original power adapters cannot be achieved, which causes complaints by the consumers, thereby affecting user experiences.

### SUMMARY

The disclosure provides a power supply optimization method adapted to an electronic device including a battery module. The method includes the following steps. A power adapter is negotiated with through a power control protocol in a power connection state to obtain a power profile. Whether the power adapter supports a variable charging power adjustment function is determined according to the power profile. When the power adapter supports the variable charging power adjustment function, whether a stored power of the battery module is less than a power threshold is determined. When the stored power is less than the power threshold, one or more of a constant current test, a constant voltage test, and a power transmission test are executed to select an algorithm for controlling a power supply behavior of the power adapter from multiple algorithms.

The disclosure also provides an electronic device, which includes a battery module, a charger integrated circuit (IC), and a processor. The battery module is configured to supply power to the electronic device. The charger IC is coupled to the battery module and negotiates with a power adapter through a power control protocol in a power connection state to obtain a power profile. The processor couples the battery module and the charger IC. The processor is configured to determine whether the power adapter supports a variable charging power adjustment function according to the power profile; when the power adapter supports the variable charging power adjustment function, determine whether a stored power of the battery module is less than a power threshold; and when the stored power is less than the power threshold, execute one or more of a constant current test, a constant voltage test, and a power transmission test to select an algorithm for controlling a power supply behavior of the power adapter from multiple algorithms.

According to the above, the electronic device and the power supply optimization method thereof of the disclosure can enable the power adapter to select the most suitable power supply algorithm after various tests to improve the charging wattage capability to increase the charging speed of the battery module, thereby bringing good experience and operating sensation to the user.

In order for the features and advantages of the disclosure to be more comprehensible, the following specific embodiments are described in detail in conjunction with the drawings.

### BRIEF DESCRIPTION OF THE DRAWINGS

FIG. 1 is a block diagram of an electronic device according to an embodiment of the disclosure.

FIG. 2A and FIG. 2B are flowcharts of a power supply optimization method according to an embodiment of the disclosure.

FIG. 3A to FIG. 3C are flowcharts of a constant current test according to an embodiment of the disclosure.

FIG. 4A to FIG. 4D are flowcharts of a constant voltage test according to an embodiment of the disclosure.

FIG. 5A and FIG. 5B are flowcharts of a power transmission test according to an embodiment of the disclosure.

### DESCRIPTION OF THE EMBODIMENTS

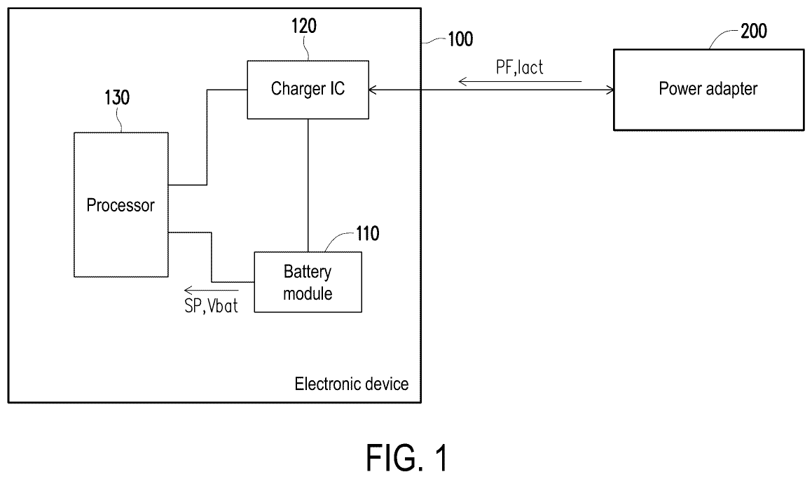

Please refer to FIG. 1. An electronic device 100 of the embodiment is, for example, a handheld electronic product such as a notebook computer, a mobile phone, and a tablet computer. The electronic device 100 includes a battery module 110, a charger integrated circuit (IC) 120, and a processor 130.

The battery module 110 may be configured to supply power to the electronic device 100 and may be built-in or external. The battery module 110 includes, for example, a battery core pack and a control circuit. The battery core pack is composed of, for example, a single or multiple battery cells (battery core units). The control circuit includes, for example, a battery gauge IC, which may calculate a stored power (for example, a battery state of charge (SOC)) SP, a battery voltage Vbat, and a charge/discharge current of the battery module 110 to be periodically transmitted to the processor 130.

A charger IC 120 is coupled to the battery module 110. The charger IC 120 may negotiate with a power adapter 200 plugged into the electronic device 100 through a power control protocol. The power adapter 200 is, for example, an alternating current (AC) adapter. In the embodiment, when the power adapter 200 is plugged into the electronic device 100, charging of the battery module 110 may begin. At the same time, the electronic device 100 also enters a power connection state indicating that the power adapter 200 is connected. In addition, when the power adapter 200 is unplugged from the electronic device 100, the electronic device 100 is released from the power connection state. The power control protocol is, for example, the USB power delivery (PD) 3.0 communication protocol launched by the USB Implementers Forum (USB-IF) organization, but the disclosure is not limited thereto.

The processor 130 is coupled to the battery module 110 and the charger IC 120, and is, for example, a central processing unit (CPU), other programmable general-purpose or specific-purpose microprocessors, digital signal processors (DSPs), programmable controllers, application specific integrated circuits (ASICs), other similar elements, or a combination of the above elements. The processor 130 may test the power adapter 200 through the charger IC 120 to select an algorithm for controlling a power supply behavior of the power adapter 200 according to a test result, thereby optimizing the power supply. An embodiment is described below to illustrate detailed steps of a power supply optimization method of the disclosure.

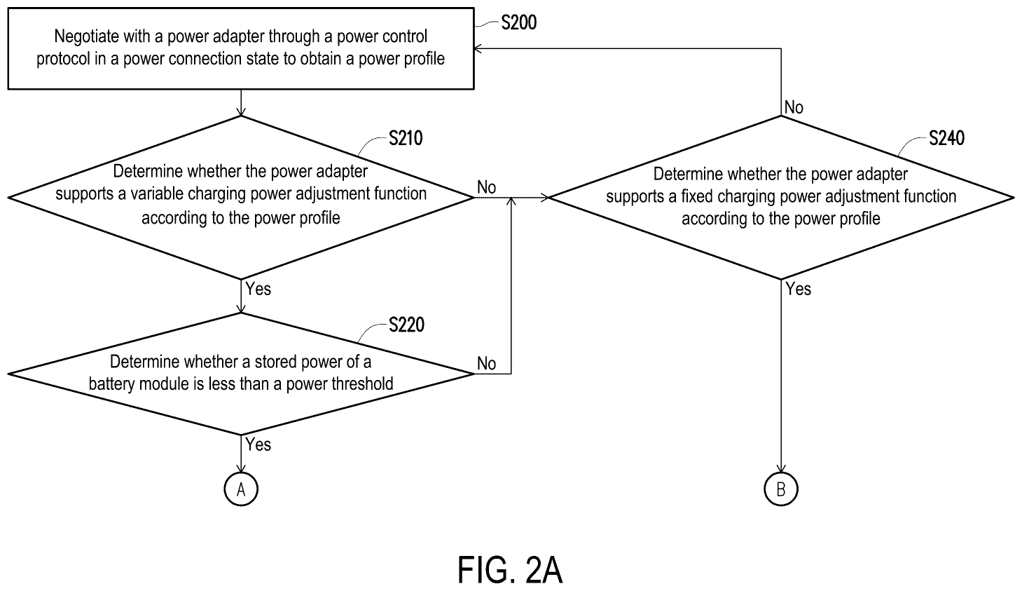

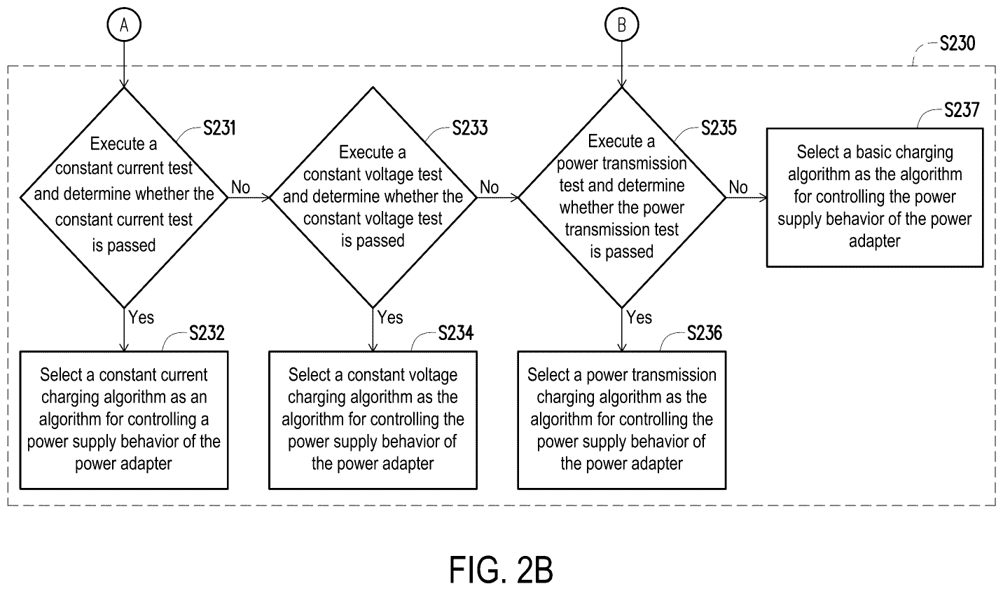

Please refer to FIG. 1, FIG. 2A, and FIG. 2B at the same time. The method of the embodiment may be adapted to the electronic device 100 of FIG. 1. The steps thereof are described below.

First, in Step S200, in the power connection state (the case where the power adapter 200 is connected), the charger IC 120 may negotiate with the power adapter 200 through the power control protocol to obtain a power profile PF. The power profile PF may include one or more power data objects (PDOs), which record specifications such as functions, current, voltage, and power supported by the power adapter 200.

Next, in Step S210, the processor 130 determines whether the power adapter 200 supports a variable charging power adjustment function according to the power profile PF obtained from the charger IC 120. The variable charging power adjustment function is, for example, a function of an augmented PDO (APDO) specified in the PD 3.0, which means that in a programmable power supply (PPS) mode, an output voltage may be adjusted within a certain range interval (for example, 3.3V to 21V).

When the power adapter 200 supports the variable charging power adjustment function, in Step S220, the processor 130 determines whether the stored power SP of the battery module 110 is less than a power threshold (for example, 85%) to prevent high wattage (for example, about watts) testing (such as a constant current test and a constant voltage test described below) in the case where current and voltage are too high.

When the stored power SP is less than the power threshold, proceed to Step S230 of FIG. 2B via Node A. In Step S230, the processor 130 executes one or more of the constant current test, the constant voltage test, and a power transmission test to select the algorithm for controlling the power supply behavior of the power adapter 200 from multiple algorithms (including a constant current charging algorithm, a constant voltage charging algorithm, a power transmission charging algorithm, and a basic charging algorithm). Specifically, as shown in FIG. 2B, Step S230 includes Step S231 to Step S237. When the stored power SP is less than the power threshold, the processor 130 first executes the constant current test and determines whether the constant current test is passed (Step S231). When the constant current test is passed, the processor 130 selects the constant current charging algorithm as the algorithm for controlling the power supply behavior of the power adapter 200 in Step S232.

When the constant current test is not passed, the processor 130 executes the constant voltage test and determines whether the constant voltage test is passed (Step S233). When the constant voltage test is passed, in Step S234, the processor 130 selects the constant voltage charging algorithm as the algorithm for controlling the power supply behavior of the power adapter 200.

When the constant voltage test is not passed, the processor 130 executes the power transmission test and determines whether the power transmission test is passed (Step S235). When the power transmission test is passed, the processor 130 selects the power transmission charging algorithm as the algorithm for controlling the power supply behavior of the power adapter in Step S236. When the power transmission test is not passed, in Step S237, the processor selects the basic charging algorithm as the algorithm for controlling the power supply behavior of the power adapter 200.

In addition, when the processor 130 determines in Step S210 that the power adapter 200 does not support the variable charging power adjustment function or the processor 130 determines in Step S220 that the stored power SP of the battery module 110 is not less than the power threshold, the processor 130 determines in Step S240 whether the power adapter 200 supports a fixed charging power adjustment function according to the power profile PF. The fixed charging power adjustment function is, for example, a function of a fixed PDO specified in the PD 3.0, which means that different levels may be used to fix the output voltage. When the power adapter does not support the fixed charging power adjustment function, return to Step S200 to continue processing.

When the power adapter 200 supports the fixed charging power adjustment function, proceed to Step S235 of FIG. 2B via Node B, so that the processor 130 executes the power transmission test to select the algorithm for controlling the power supply behavior of the power adapter 200 from the power transmission charging algorithm and the basic charging algorithm.

It should be noted that the power adapter 200 performs the constant current test, the constant voltage test, and the power transmission test in the PPS mode. In addition, the constant current charging algorithm, the constant voltage charging algorithm, the power transmission charging algorithm, and the basic charging algorithm may control the current, the voltage, and the power provided by the power adapter 200 according to user situations, such as temperature, screen brightness, during a game, and other factors to optimize the power supply. The constant current charging algorithm and the constant voltage charging algorithm belong to high wattage (for example, about 65 watts) control. The constant current charging algorithm is adapted to the power adapter 200 with good current control, and a charging curve thereof is relatively smooth. A charging curve of the constant voltage charging algorithm has some sawtooth-shaped changes, and a charging efficiency thereof is slightly lower than that of the constant current charging algorithm. The power transmission charging algorithm belongs to medium wattage (for example, about 15 watts to 36 watts) control and uses a maximum voltage of 12V and a current of 3 A. However, for energy conversion efficiency, a voltage of 9V and a current of 2 A are usually used. The basic charging algorithm belongs to general low wattage control and only uses a maximum voltage of 9V and a current of 1 A or 2A.

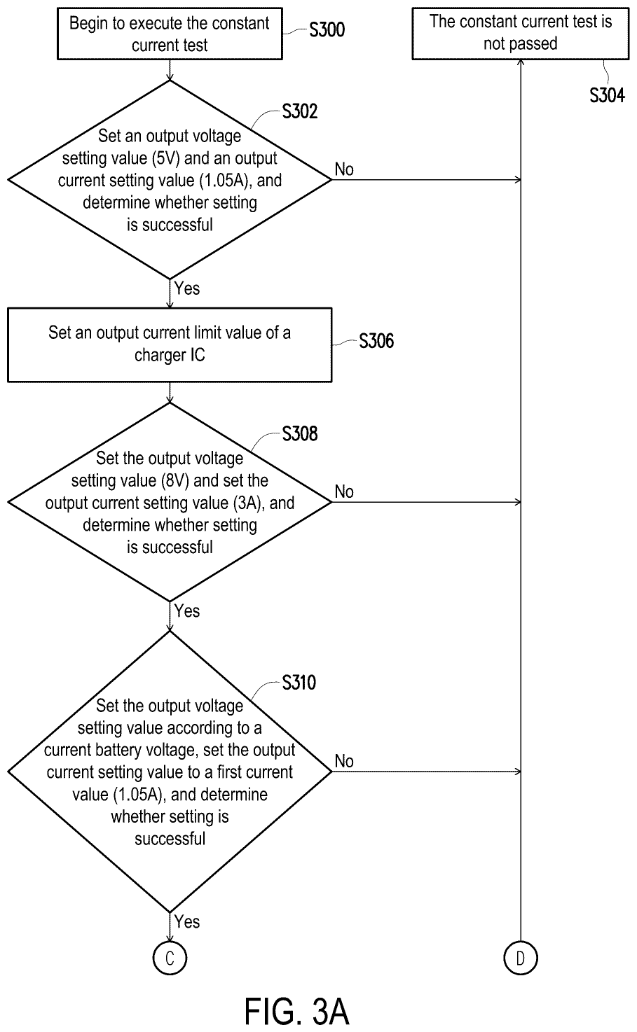

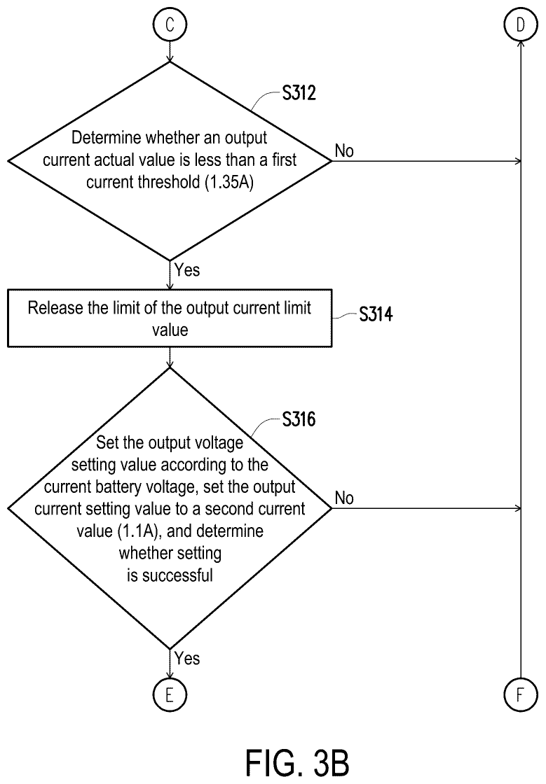

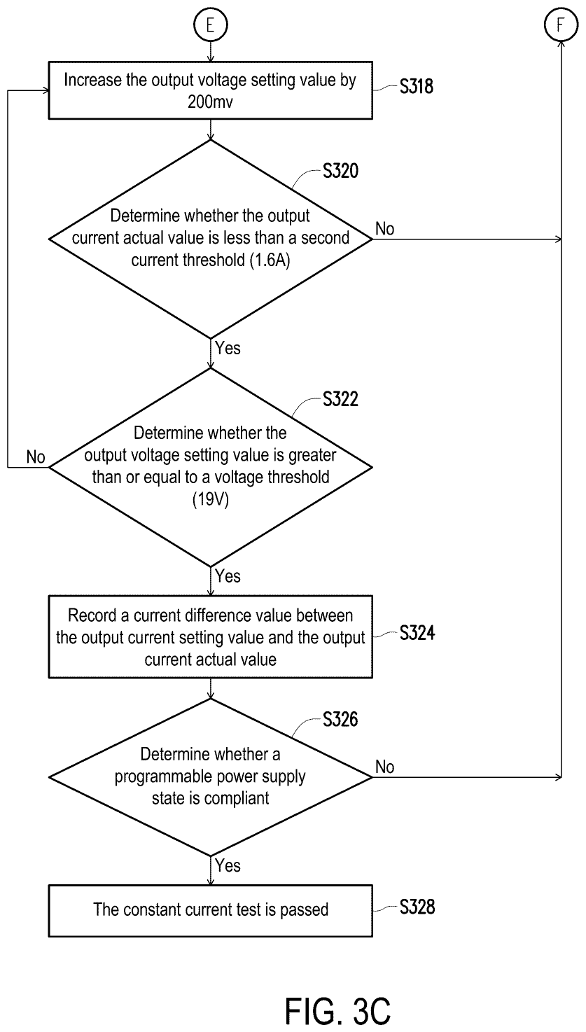

The implementation details of the constant current test, the constant voltage test, and the power transmission test are respectively described below. The constant current test is mainly to test a current control capability of the power adapter 200. For detailed description of the steps of the processor 130 executing the constant current test and determining whether the constant current test is passed (Step S231 of FIG. 2B), reference may be made to each step in FIG. 3A to FIG. 3C.

First, in Step S300, processor 130 begins to execute the constant current test. Next, in Step S302, the processor 130 sets an output voltage setting value of the power adapter 200 to 5V and sets an output current setting value of the power adapter 200 to 1.05A through the charger IC 120. The power adapter 200 may return a message to the processor 130, so that the processor may determine whether setting is successful. When the setting is not successful, in Step S304, the processor 130 determines that the constant current test is not passed.

When the setting is successful, in Step S306, the processor 130 sets an output current limit value of the charger IC 120 to 1.5A. Next, in Step S308, the processor 130 sets the output voltage setting value of the power adapter 200 to 8V and sets the output current setting value of the power adapter 200 to 3A through the charger IC 120. The power adapter 200 may return a message to the processor 130, so that the processor 130 may determine whether setting is successful. When the setting is not successful, in Step S304, the processor 130 determines that the constant current test is not passed.

When the setting is successful, in Step S310, the processor 130 sets the output voltage setting value of the power adapter 200 through the charger IC 120 according to a current battery voltage Vbat of the battery module 110, and sets the output current setting value of the power adapter 200 to a first current value (for example, 1.05A) through the charger IC 120. For example, the processor 130 may set the output voltage setting value of the power adapter 200 to twice the current battery voltage Vbat plus a voltage offset (for example, 200 mv) and set the output current setting value of the power adapter 200 to 1.05A through the charger IC 120. The power adapter 200 may return a message to the processor 130, so that the processor 130 may determine whether setting is successful. When the setting is not successful, in Step S304, the processor 130 determines that the constant current test is not passed.

When the setting is successful, proceed to Step S312 of FIG. 3B via Node C. In Step S312, the charger IC 120 determines whether an output current actual value Iact actually output by the power adapter 200 to the electronic device 100 is less than a first current threshold (for example, 1.35A). When the output current actual value Iact is not less than the first current threshold, return to Step S304 of FIG. 3A via Node D, and the processor 130 determines that the constant current test is not passed. It should be noted that in the embodiment, the “output current setting value” and the “output voltage setting value” refer to values when the charger IC 120 sets the output current and the output voltage of the power adapter 200 through the power control protocol, the “output current actual value” refers to a current value actually output by the power adapter 200 to the electronic device 100.

When the output current actual value Iact is less than the first current threshold, in Step S314, the processor 130 releases the limit of the output current limit value of the charger IC 120. Then, in Step S316, the processor 130 sets the output voltage setting value of the power adapter through the charger IC 120 according to the current battery voltage Vbat of the battery module 110, and sets the output current setting value of the power adapter 200 to a second current value (for example, 1.1A) through the charger IC 120. The second current value is greater than the first current value. For example, the processor 130 may set the output voltage setting value of the power adapter 200 to twice the current battery voltage Vbat plus the voltage offset (for example, mv) and set the output current setting value of the power adapter 200 to 1.1A through the charger IC 120. The power adapter 200 may return a message to the processor 130, so that the processor 130 may determine whether setting is successful. When the setting is not successful, return to Step S304 of FIG. 3A via Node D, and the processor 130 determines that the constant current test is not passed.

When the setting is successful, the processor 130 repeatedly sets the output voltage setting value of the power adapter 200 through the charger IC 120 by gradually increasing the output voltage setting value and determines whether the current output current actual value Iact is less than a second current threshold (for example, 1.6A) until the output voltage setting value is greater than or equal to a voltage threshold (for example, 19V). Specifically, when the setting is successful, proceed to Step S318 of FIG. 3C via Node E. In Step S318, the processor 130 increases the output voltage setting value of the power adapter 200 by 200 mv through the charger IC 120. Next, in Step S320, the processor 130 determines whether the current output current actual value Iact is less than the second current threshold (for example, 1.6A) through the charger IC 120. If the current output current actual value Iact is not less than the second current threshold, return to Step S304 of FIG. 3A via Node D and Node F, and the processor 130 determines that the constant current test is not passed.

If the current output current actual value Iact is less than the second current threshold, in Step S322, the processor 130 determines whether the output voltage setting value of the power adapter 200 is greater than or equal to the voltage threshold (for example, 19V). If the output current setting value is not greater than or equal to the voltage threshold, return to Step S318 to continue increasing the output voltage setting value.

If the output current setting value is set to be greater than or equal to the voltage threshold, in Step S324, the processor 130 records a current difference value between the output current setting value and the output current actual value Iact to be used to execute subsequent algorithms.

Next, in Step S326, the processor 130 determines whether a programmable power supply state of the power adapter 200 is compliant. For example, the processor 130 may check whether a real-time flag of the power adapter 200 is set, and whether the output voltage and the output current of the power adapter 200 are within ranges of being compliant.

If the real-time flag of the power adapter 200 is set, and the output voltage and the output current are also within the ranges of being compliant, it means that the programmable power supply state is compliant, in Step S328, the processor 130 determines that the constant current test is passed. On the contrary, if the programmable power supply state is not compliant, return to Step S304 of FIG. 3A via Node D and Node F, and the processor 130 determines that the constant current test is not passed.

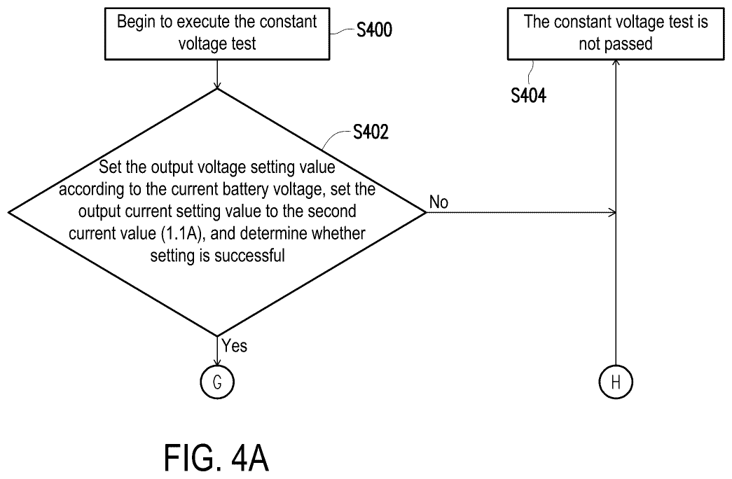

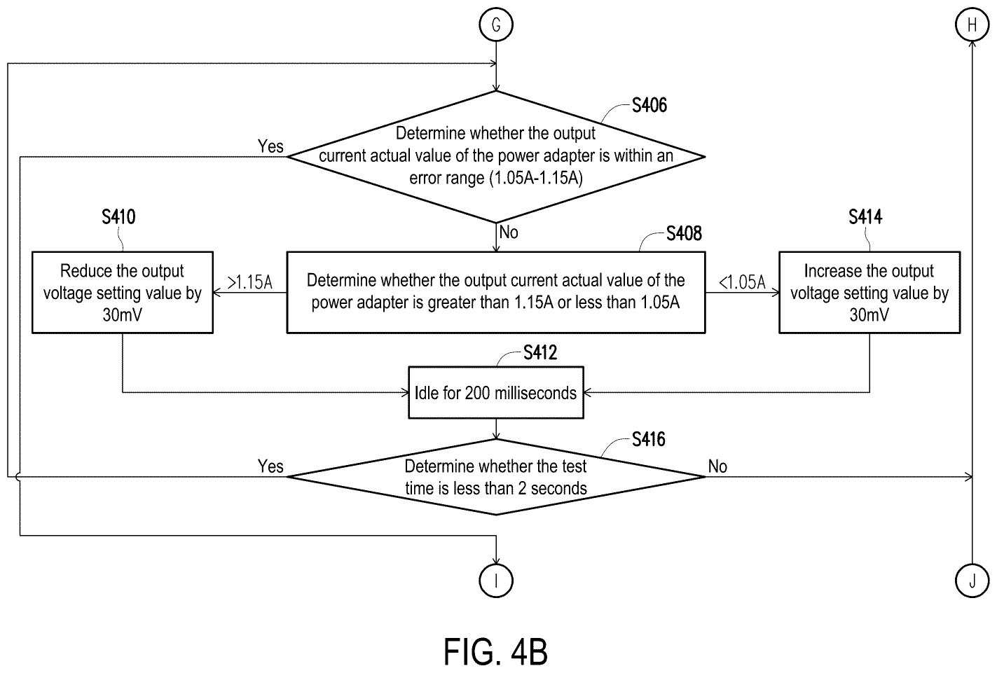

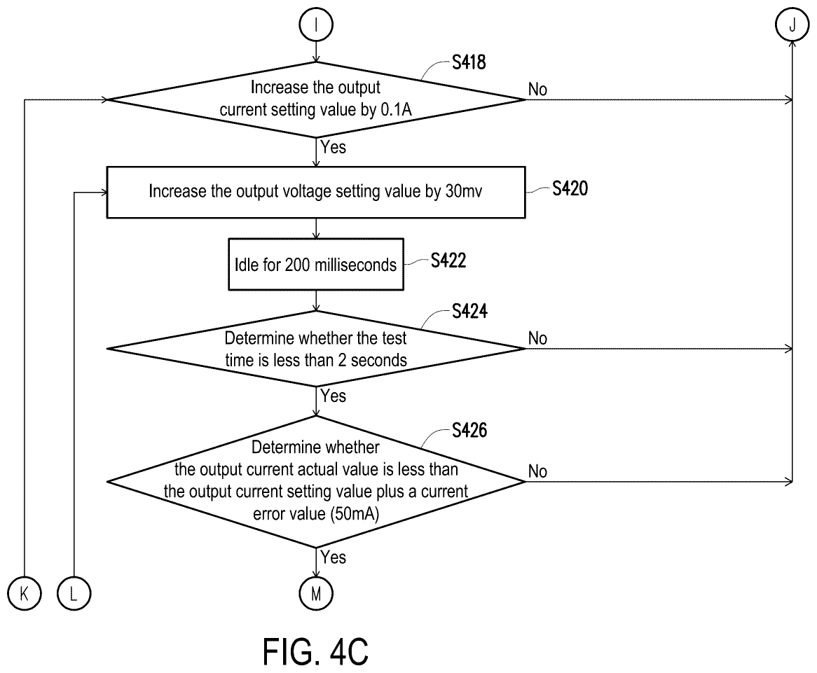

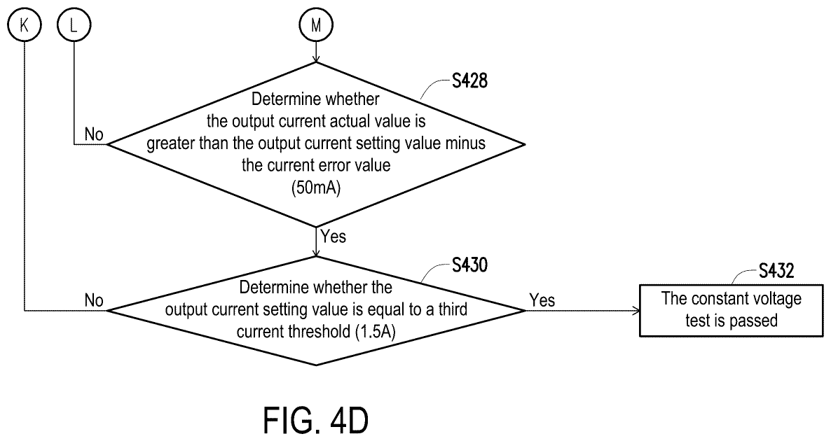

The constant voltage test is mainly to test a voltage control capability of the power adapter 200. For detailed description of the steps of the processor 130 executing the constant voltage test and determining whether the constant voltage test is passed (Step S233 of FIG. 2B), reference may be made to each step in FIG. 4A to FIG. 4D.

First, in Step S400, the processor 130 begins to execute the constant voltage test. Next, in Step S402, the processor 130 sets the output voltage setting value of the power adapter 200 through the charger IC 120 according to the current battery voltage Vbat of the battery module 110, and sets the output current setting value of the power adapter 200 to the second current value (for example, 1.1A) through the charger IC 120. For example, the processor 130 may set the output voltage setting value of the power adapter 200 to twice the current battery voltage Vbat plus the voltage offset (for example, 200 mv) and set the output current setting value of the power adapter 200 to 1.1A through the charger IC 120. The power adapter 200 may return a message to the processor 130, so that the processor 130 may determine whether setting is successful. When the setting is not successful, in Step S404, the processor 130 determines that the constant voltage test is not passed.

When the setting is successful, proceed to Step S406 of FIG. 4B via Node G. In Step S406, the charger IC 120 determines whether the output current actual value Iact of the power adapter 200 is within an error range (for example, 1.05A to 1.15A).

If the output current actual value Iact is not within the error range, the processor 130 may repeatedly fine-tune the output voltage setting value of the power adapter 200 through the charger IC 120 until the output current actual value Iact is within the error range. Specifically, if the output current actual value Iact is not within the error range, in Step S408, the processor 130 determines whether the output current actual value Iact of the power adapter 200 is greater than 1.15A or less than 1.05A. When the actual current value Iact is greater than 1.15A, in Step S410, the processor 130 reduces the output voltage setting value by 30 mV through the charger IC 120. Then, proceed to Step S412, and the processor 130 is idle for 200 milliseconds. On the other hand, when the actual current value Iact is less than 1.05A, in Step S414, the processor 130 increases the output voltage setting value by 30 mV through the charger IC 120. Then, proceed to Step S412, and the processor 130 is idle for 200 milliseconds.

Next, in Step S416, the processor 130 determines whether the entire test time is less than seconds. If yes, return to Step S406 to continue determining. If not, return to Step S404 of FIG. 4A via Node H, and the processor 130 determines that the constant voltage test is not passed.

If the processor 130 determines in Step S406 that the output current actual value Iact is within the error range, the processor 130 repeatedly fine-tunes the output current setting value and the output voltage setting value of the power adapter 200 through the charger IC 120 by gradually increasing the output current setting value and the output voltage setting value, and determines whether the current output current actual value Iact of the power adapter 200 is less than the output current setting value plus a current error value (for example, 50 mA) through the charger IC 120 until the output current setting value is equal to a third current threshold (for example, 1.5A). Specifically, when the output current actual value Iact is within the error range, proceed to Step S418 of FIG. 4C via Node I. In Step S418, the processor 130 increases the output current setting value of the power adapter 200 by 0.1A through the charger IC 120. Next, in Step S420, the processor 130 increases the output voltage setting value of the power adapter 200 by 30 mv through the charger IC 120. In Step S422, the processor 130 is idle for 200 milliseconds. Next, in Step S424, the processor 130 determines whether the entire test time is less than 2 seconds. If yes, proceed to Step S426. If not, return to Step S404 of FIG. 4A via Node H and Node J, and the processor 130 determines that the constant voltage test is not passed.

In Step S426, the processor 130 determines whether the current output current actual value Iact of the power adapter 200 is less than the output current setting value plus the current error value (for example, 50 mA) through the charger IC 120. If the current output current actual value Iact is not less than the output current setting value plus the current error value, return to Step S404 of FIG. 4A via Node H and Node J, and the processor 130 determines that the constant voltage test is not passed. If the current output current actual value Iact is less than the output current setting value plus the current error value, proceed to Step S428 of FIG. 4D via Node M.

In Step S428, the processor 130 determines whether the current output current actual value Iact of the power adapter 200 is greater than the output current setting value minus the current error value (for example, 50 mA) through the charger IC 120. If the current output current actual value Iact is not greater than the output current setting value minus the current error value, return to Step S420 of FIG. 4C via Node L to continue increasing the output voltage setting value.

If the current output current actual value Iact is greater than the output current setting value minus the current error value, in Step S430, the processor 130 determines whether the output current setting value is equal to the third current threshold (for example, 1.5A). If yes, in Step S432, the processor 130 determines that the constant voltage test is passed. If not, return to Step S418 of FIG. 4C via Node K to continue increasing the output current setting value.

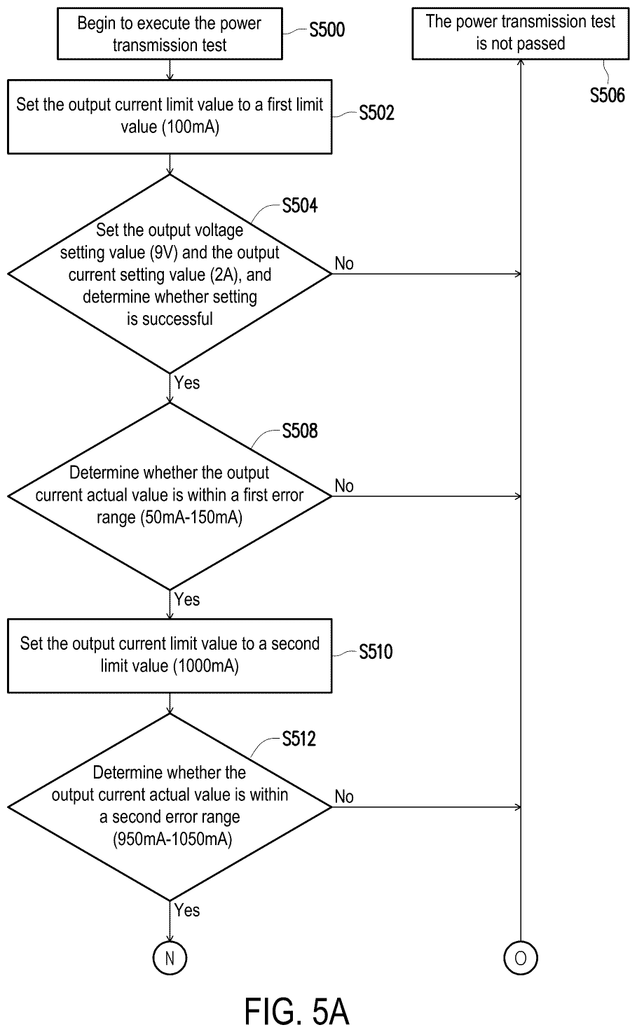

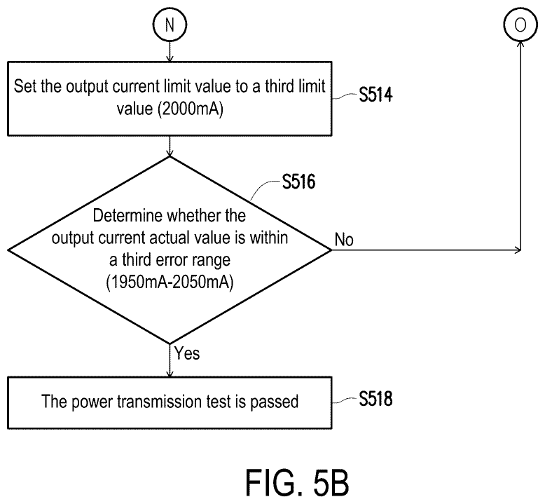

The power transmission test is mainly to test whether the power adapter 200 may be controlled to output a fixed level (of voltage/current). For detailed description of the steps of the processor 130 executing the power transmission test and determining whether the power transmission test is passed (Step S235 of FIG. 2B), reference may be made to each step in FIG. 5A and FIG. 5B.

First, in Step S500, the processor 130 begins to execute the power transmission test. Next, in Step S502, the processor 130 sets the output current limit value of the charger IC 120 to a first limit value (100 mA). Next, in Step S504, the processor 130 sets the output voltage setting value of the power adapter 200 to 9V and sets the output current setting value of the power adapter to 2A through the charger IC 120. The power adapter 200 may return a message to the processor 130, so that the processor 130 may determine whether setting is successful. When the setting is not successful, in Step S506, the processor 130 determines that the power transmission test is not passed.

When the setting is successful, in Step S508, the processor 130 determines whether the output current actual value Iact of the power adapter 200 is within a first error range (for example, mA to 150 mA) through the charger IC 120. If the output current actual value Iact is not within the first error range, in Step S506, the processor 130 determines that the power transmission test is not passed. It should be noted that the first error range of the embodiment is a current output current limit value of the charger IC 120 plus or minus 50 mA and may change along with changes in the current output current limit value of the charger IC 120. Similarly, a second error range and a third error range described later also change along with changes in the current output current limit value of the charger IC 120.

If the output current actual value Iact is within the first error range, in Step S510, the processor 130 sets the output current limit value of the charger IC 120 to a second limit value (1000 mA). Next, in Step S512, the processor 130 determines whether the output current actual value Iact of the power adapter 200 is within the second error range (for example, 950 mA to mA) through the charger IC 120. If the output current actual value Iact is not within the second error range, in Step S506, the processor 130 determines that the power transmission test is not passed.

If the output current actual value Iact is within the second error range, proceed to Step S514 of FIG. 5B via Node N. In Step S514, the processor 130 sets the output current limit value of the charger IC 120 to a third limit value (2000 mA). Next, in Step S516, the processor 130 determines whether the output current actual value Iact of the power adapter 200 is within the third error range (for example, 1950 mA to 2050 mA) through the charger IC 120. If yes, in Step S518, the processor 130 determines that the power transmission test is passed. If not, return to Step S506 of FIG. 5A via Node O, and the processor 130 determines that the power transmission test is not passed.

It should be noted that the relevant actual values of the current and the voltage used in the constant current test are only for reference, may be arbitrarily changed by persons skilled in the art according to the actual situation in operation, and are not intended to limit the disclosure.

In summary, the electronic device and the power supply optimization method thereof of the disclosure can enable the power adapter to select the most suitable power supply algorithm after various tests to prevent the case of overcurrent or insufficient current. In this way, even if the power adapter from the original factory is not used, the charging wattage capability can still be maximized to increase the charging speed of the battery module, thereby bringing good experience and operating sensation to the user.

What is claimed is:

1. A power supply optimization method, adapted to an electronic device comprising a battery module, the power supply optimization method comprising:
negotiating with a power adapter through a power control protocol in a power connection state to obtain a power profile;
determining whether the power adapter supports a variable charging power adjustment function according to the power profile;
when the power adapter supports the variable charging power adjustment function, determining whether a stored power of the battery module is less than a power threshold; and
when the stored power is less than the power threshold, executing one or more of a constant current test, a constant voltage test, and a power transmission test to select an algorithm for controlling a power supply behavior of the power adapter from a plurality of algorithms.

2. The power supply optimization method according to claim 1, wherein the algorithms comprise a constant current charging algorithm, a constant voltage charging algorithm, a power transmission charging algorithm, and a basic charging algorithm.

3. The power supply optimization method according to claim 2, wherein the step of executing one or more of the constant current test, the constant voltage test, and the power transmission test to select the algorithm for controlling the power supply behavior of the power adapter from the algorithms comprises:
executing the constant current test and determining whether the constant current test is passed; and
when the constant current test is passed, selecting the constant current charging algorithm as the algorithm for controlling the power supply behavior of the power adapter.

4. The power supply optimization method according to claim 3, wherein the step of executing the constant current test and determining whether the constant current test is passed comprises:
setting an output voltage setting value of the power adapter according to a current battery voltage of the battery module, setting an output current setting value of the power adapter to a first current value, and determining whether setting is successful:
when the setting is successful, determining whether an output current actual value of the power adapter is less than a first current threshold;
when the output current actual value is less than the first current threshold, setting the output voltage setting value of the power adapter according to the current battery voltage, setting the output current setting value of the power adapter to a second current value, and determining whether setting is successful, wherein the second current value is greater than the first current value;
when the setting is successful, repeatedly setting the output voltage setting value of the power adapter by gradually increasing the output voltage setting value, and determining whether the current output current actual value is less than a second current threshold until the output voltage setting value is greater than or equal to a voltage threshold;
if the current output current actual value is not less than the second current threshold, determining that the constant current test is not passed;
if the current output current actual value is less than the second current threshold and the output current setting value is set to be greater than or equal to the voltage threshold, recording a current difference value between the output current setting value and the output current actual value;
determining whether a programmable power supply state is compliant; and
if the programmable power supply state is compliant, determining that the constant current test is passed.

5. The power supply optimization method according to claim 3, wherein the step of executing one or more of the constant current test, the constant voltage test, and the power transmission test to select the algorithm for controlling the power supply behavior of the power adapter from the algorithms further comprises:
when the constant current test is not passed, executing the constant voltage test and determining whether the constant voltage test is passed; and
when the constant voltage test is passed, selecting the constant voltage charging algorithm as the algorithm for controlling the power supply behavior of the power adapter.

6. The power supply optimization method according to claim 5, wherein the step of executing the constant voltage test and determining whether the constant voltage test is passed comprises:
setting an output voltage setting value of the power adapter according to a current battery voltage of the battery module, setting an output current setting value of the power adapter to a second current value, and determining whether setting is successful;
when the setting is successful, determining whether an output current actual value of the power adapter is within an error range;
if the output current actual value is not within the error range, repeatedly fine-tuning the output voltage setting value until the output current actual value is within the error range;
if the output current actual value is within the error range, repeatedly fine-tuning the output current setting value and the output voltage setting value by gradually increasing the output current setting value and the output voltage setting value, and determining whether the current output current actual value is less than the output current setting value plus a current error value until the output current setting value is equal to a third current threshold;
if the current output current actual value is not less than the output current setting value plus the current error value, determining that the constant voltage test is not passed; and
if the current output current actual value is less than the output current setting value plus the current error value and the output current setting value is equal to the third current threshold, determining that the constant voltage test is passed.

7. The power supply optimization method according to claim 5, wherein the step of executing one or more of the constant current test, the constant voltage test, and the power transmission test to select the algorithm for controlling the power supply behavior of the power adapter from the algorithms further comprises:
when the constant voltage test is not passed, executing the power transmission test and determining whether the power transmission test is passed;
when the power transmission test is passed, selecting the power transmission charging algorithm as the algorithm for controlling the power supply behavior of the power adapter; and
when the power transmission test is not passed, selecting the basic charging algorithm as the algorithm for controlling the power supply behavior of the power adapter.

8. The power supply optimization method according to claim 5, wherein the step of executing the power transmission test and determining whether the power transmission test is passed comprises:
setting an output current limit value to a first limit value, and determining whether an output current actual value of the power adapter is within a first error range:
if the output current actual value is within the first error range, setting the output current limit value to a second limit value, and determining whether the output current actual value is within a second error range:
if the output current actual value is within the second error range, setting the output current limit value to a third limit value, and determining whether the output current actual value is within a third error range; and
if the output current actual value is within the third error range, determining that the power transmission test is passed.

9. The power supply optimization method according to claim 2, further comprising:
when the power adapter does not support the variable charging power adjustment function or the stored power of the battery module is not less than the power threshold, determining whether the power adapter supports a fixed charging power adjustment function according to the power profile; and
when the power adapter supports the fixed charging power adjustment function, executing the power transmission test to select the algorithm for controlling the power supply behavior of the power adapter from the power transmission charging algorithm and the basic charging algorithm.

10. An electronic device, comprising:
a battery module, configured to supply power to the electronic device;
a charger integrated chip (IC), coupled to the battery module and configured to negotiate with a power adapter through a power control protocol in a power connection state to obtain a power profile; and
a processor, coupled to the battery module and the charger IC, and configured to:
determine whether the power adapter supports a variable charging power adjustment function according to the power profile;
when the power adapter supports the variable charging power adjustment function, determine whether a stored power of the battery module is less than a power threshold; and
when the stored power is less than the power threshold, execute one or more of a constant current test, a constant voltage test, and a power transmission test to select an algorithm for controlling a power supply behavior of the power adapter from a plurality of algorithms.

11. The electronic device according to claim 10, wherein the algorithms comprise a constant current charging algorithm, a constant voltage charging algorithm, a power transmission charging algorithm, and a basic charging algorithm.

12. The electronic device according to claim 11, wherein the processor executes the constant current test and determines whether the constant current test is passed,
when the constant current test is passed, the processor selects the constant current charging algorithm as the algorithm for controlling the power supply behavior of the power adapter.

13. The electronic device according to claim 12, wherein the processor sets an output voltage setting value of the power adapter through the charger IC according to a current battery voltage of the battery module, sets an output current setting value of the power adapter to a first current value through the charger IC, and determines whether setting is successful,
when the setting is successful, the charger IC determines whether an output current actual value of the power adapter is less than a first current threshold,
when the output current actual value is less than the first current threshold, the processor sets the output voltage setting value of the power adapter through the charger IC according to the current battery voltage, sets the output current setting value of the power adapter to a second current value through the charger IC, and determines whether setting is successful, wherein the second current value is greater than the first current value,
when the setting is successful, the processor repeatedly sets the output voltage setting value of the power adapter through the charger IC by gradually increasing the output voltage setting value, and determines whether the current output current actual value is less than a second current threshold until the output voltage setting value is greater than or equal to a voltage threshold,
if the current output current actual value is not less than the second current threshold, the processor determines that the constant current test is not passed,
if the current output current actual value is less than the second current threshold and the output current setting value is set to be greater than or equal to the voltage threshold, the processor records a current difference value between the output current setting value and the output current actual value,
the processor determines whether a programmable power supply state is compliant,
if the programmable power supply state is compliant, the processor determines that the constant current test is passed.

14. The electronic device according to claim 12, wherein when the constant current test is not passed, the processor executes the constant voltage test and determines whether the constant voltage test is passed,
when the constant voltage test is passed, the processor selects the constant voltage charging algorithm as the algorithm for controlling the power supply behavior of the power adapter.

15. The electronic device according to claim 14, wherein the processor sets an output voltage setting value of the power adapter through the charger IC according to a current battery voltage of the battery module, sets an output current setting value of the power adapter to a second current value through the charger IC, and determines whether setting is successful,
when the setting is successful, the charger IC determines whether an output current actual value of the power adapter is within an error range,
if the output current actual value is not within the error range, the processor repeatedly fine-tunes the output voltage setting value through the charger IC until the output current actual value is within the error range,
if the output current actual value is within the error range, the processor repeatedly fine-tunes the output current setting value and the output voltage setting value through the charger IC by gradually increasing the output current setting value and the output voltage setting value, and determines whether the current output current actual value is less than the output current setting value plus a current error value through the charger IC until the output current setting value is equal to a third current threshold,
if the current output current actual value is not less than the output current setting value plus the current error value, the processor determines that the constant voltage test is not passed,
if the current output current actual value is less than the output current setting value plus the current error value and the output current setting value is equal to the third current threshold, the processor determines that the constant voltage test is passed.

16. The electronic device according to claim 14, wherein when the constant voltage test is not passed, the processor executes the power transmission test and determines whether the power transmission test is passed,
when the power transmission test is passed, the processor selects the power transmission charging algorithm as the algorithm for controlling the power supply behavior of the power adapter,
when the power transmission test is not passed, the processor selects the basic charging algorithm as the algorithm for controlling the power supply behavior of the power adapter.

17. The electronic device according to claim 14, wherein the processor sets an output current limit value of the charger IC to a first limit value, and determines whether an output current actual value of the power adapter is within a first error range through the charger IC,
if the output current actual value is within the first error range, the processor sets the output current limit value of the charger IC to a second limit value, and determines whether the output current actual value is within a second error range through the charger IC,
if the output current actual value is within the second error range, the processor sets the output current limit value of the charger IC to a third limit value, and determines whether the output current actual value is within a third error range through the charger IC,
if the output current actual value is within the third error range, the processor determines that the power transmission test is passed.

18. The electronic device according to claim 11, wherein:
when the power adapter does not support the variable charging power adjustment function or the stored power of the battery module is not less than the power threshold, the processor determines whether the power adapter supports a fixed charging power adjustment function according to the power profile,
when the power adapter supports the fixed charging power adjustment function, the processor executes the power transmission test to select the algorithm for controlling the power supply behavior of the power adapter from the power transmission charging algorithm and the basic charging algorithm.
